(19) United States
(12) Patent Application Publication
(10) Pub. No.: US 2008/0205243 A1
(43) Pub. Date: Aug. 28, 2008

(54) Optical Head Apparatus and Optical Information Recording or Reproducing Apparatus Having the Same

(75) Inventor: Ryuichi Katayama, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 11/816,072

(22) PCT Filed: Feb. 15, 2006
(86) PCT No.: PCT/JP2006/302645

§ 371 Date: Aug. 10, 2007

(30) Foreign Application Priority Data
Feb. 16, 2005 (JP) 2005-039817

(51) Int. Cl. G11B 7/135

(52) U.S. Cl. 369/112.03

(57) ABSTRACT

An object of the present invention is to provide an optical head apparatus having a high signal to noise ratio in an RF signal in a simple circuit configuration, and an optical information recording or reproducing apparatus that uses it. The optical head apparatus includes a light source, an objective lens configured to focus an output light beam from the light source onto a disc-shaped optical recording medium, and a light detecting unit configured to receive a reflection light beam from the optical recording medium, and further includes an optical diffraction element configured to separate said reflection light beam into a first light beam group and a second light beam group, wherein the optical diffraction element generates the first light beam group from an entire section region of the reflection light beam and said second light beam group from at least a part of the section region of the reflection light beam. The light detector receives the first light beam group and the second light beam group by different light receiving sections, in order to detect a track error signal used for a track servo and a radial tilt signal indicating the radial tilt of the optical recording medium.

### TECHNICAL FIELD

The present invention relates to an optical head apparatus for performing recording into or reproduction from an optical recording medium, and an optical information recording or reproducing apparatus that contains the optical head apparatus. More particularly, the present invention relates to an optical head apparatus that can detect a radial tilt of an optical recording medium and an optical information recording or reproducing apparatus that uses it.

### BACKGROUND ART

In accompaniment with the advancement of information society, storage of a large quantity of information is required, and various methods to attain it are known. Among them, an optical information recording or reproducing apparatus contains an optical head apparatus that writes/reads information to and from an optical recording medium (for example, a DVD disc). The optical recording medium contains a flat recording plane used to record the information. The optical head apparatus performs the writing/reading of the information while scanning the flat recording plane. A record density of the optical recording medium is inversely proportional to the square of the diameter of a focused beam spot formed on the optical recording medium by using the optical head apparatus. That is, as the diameter of the focused beam spot is smaller, the record density is higher. The diameter of the focused beam spot is inversely proportional to the number of openings of an objective lens in the optical head apparatus. That is, as the number of the openings of the objective lens is higher, the diameter of the focused beam spot is smaller.

On the other hand, when the optical recording medium is tilted in a radial direction with respect to the optical axis of the objective lens, the coma aberration caused based on its tilt (radial tilt) disturbs the shape of the focused beam spot, and the recording or reproducing property is degraded. The coma aberration is proportional to three power of the number of the openings of the objective lens. Thus, as the number of the openings of the objective lens is larger, a margin of the recording or reproducing property of the optical recording medium in the radial tilt becomes narrower. Therefore, the optical information recording or reproducing apparatus having the optical head apparatus which uses the objective lens of the higher numerical aperture is required to detect and compensate the radial tilt of the optical recording medium. The technique for detecting the radial tilt of the optical recording medium is known from, for example, Japanese Laid Open Patent Applications (JP-P2001-110074A, and JP-P2003-346365A).

FIG. 1 is a diagram showing a configuration of the optical head apparatus in the Japanese Laid Open Patent Application (JP-P2001-110074A) (the first related art). As shown in FIG. 1, light beam outputted from a semiconductor laser 101 is made parallel by a collimator lens 102, and about 50% transmits a beam splitter 108 and focused onto a disc 106 by an objective lens 105. The reflection light beam beams from the disc 106 transmits in a direction opposite to the foregoing direction, and about 50% is reflected by the beam splitter 108, transmits a lens 109 and received a light detector 110.

FIG. 2 is a diagram showing a configuration of the light detector 110. Light receiving sections of the light detector 110 are divided into eight light receiving sections 111a,111b, 112a, 112b, 113a, 113b, 114a and 114b by three division lines parallel to the tangential direction of the disc 106 and a division line parallel to the radial direction. The outputs from the light receiving sections 111a and 112a are connected to a phase comparator 115a, and a phase difference is determined by the phase comparator 115a. The outputs from the light receiving sections 113a and 114a are connected to a phase comparator 115b, and a phase difference is determined by the phase comparator 115b. The outputs from the light receiving sections 111b and 112b are connected to a phase comparator 115c, and a phase difference is determined by the phase comparator 115c. The outputs from the light receiving sections 113b and 114b are connected to a phase comparator 115d, and the phase difference is determined by the phase comparator 115d.

The outputs from the phase comparators 115a and 115b are connected to an adder 116a, and a summation of them is calculated by the adder 116a, and a phase difference signal for the outer side of the light beam in the radial direction of the disc 106 is obtained. The outputs from the phase comparators 115c and 115d are connected to an adder 116b, and a summation of them is calculated by the adder 116b, and a phase difference signal for the inner side of the light beams in the radial direction of the disc 106 is obtained. The outputs from the adders 116a and 116b are connected to a subtracter 117a, and a difference between them is calculated by the subtracter 117a, and a first output signal 118 is obtained. The first output signal 118 is the radial tilt signal indicating the radial tilt of the disc 106. Also, the outputs from the adders 116a and 116b are connected to an adder 117b, and a summation of them is calculated by the adder 117b, and a second output signal 119 is obtained. The second output signal 119 is a track error signal used for a track servo.

However, the optical head apparatus in the first related art requires the subtracter for obtaining the radial tilt signal and the adder for obtaining the track error signal used for track servo, in addition to the four phase comparators and the two adders, in order to generate the track error signal and the radial tilt signal. Thus, the configuration of a circuit is complex. Also, an RF signal is given as a summation of the outputs from the eight light receiving sections. Therefore, since the number of the light receiving sections to obtain the summation of the outputs is great, noise of the circuit for performing current−voltage conversion becomes high and the signal to noise ratio in the RF signal is low.

FIG. 3 is a diagram showing the configuration of the optical head apparatus disclosed in Japanese Laid Open Patent Application (JP-P2003-346365A) (a second related art). As shown in FIG. 3, in the optical head apparatus in the second related art, a light beam outputted from a semiconductor laser 201 is made parallel by a collimator lens 202, divided into the three light beams of a 0-th light beam serving as a main beam and±first order diffraction light beams serving as sub beams by an optical diffraction element 207. Those light beams are supplied as P polarization light beam to a polarization beam splitter 203, and about 100% transmits a ¼ wavelength (¼ λ) plate 204 and the light beam is converted from a linear polarization light beam to a circular polarization light beam and focused onto a disc 206 by an objective lens 205. The three reflection light beams from the disc 206 transmits the objective lens 205 in the opposite direction, transmits the ¼ wavelength plate 204 and are converted from the circular polarization light beam into a linear polarization light beam in which an approach route and the polarization direction are orthogonal, and then supplied as S polarization to the polarization beam splitter 203. Then, about 100% is reflected and transmits a cylindrical lens 208 and a lens 209 and then is received by a light detector 210.

FIG. 4 is a plan view showing the configuration of the optical diffraction element 207. As shown in FIG. 4, in the optical diffraction element 207, a diffractive grating is formed in only an inner region 211 having a diameter that is smaller than the effective diameter of the objective lens 205 indicated by a dotted line in FIG. 4. A main beam includes both of a light beam transmitting the inside of the region 211 and a light beam transmitting the outside thereof, and a sub beam includes only the light beam diffracted inside the region 211. The three focused beam spots appear on the same track of the disc 206. The three reflection light beams from the disc 206 are received by the different light receiving sections of the light detector 210. In accordance with the output from the light receiving section for receiving the main beam, a phase difference signal for the entire light beam is obtained. The phase difference signal for the entire light beam is a track error signal used for track serve. Also, in accordance with the outputs from the light receiving sections for receiving the sub beam, a phase difference signal for the inner portion of the light beam is obtained. When the track servo is applied, the phase difference signal for the inner portion of the light beam is a radial tilt signal indicating the radial tilt of the disc 206.

Also, in the optical head apparatus of the second related art, the phase difference signal for the entire light beam is the track error signal used for the track servo, and the phase difference signal for the inner portion of the light beam is the radial tilt signal. Also, the phase difference signal for the inner portion of the light beam is obtained in accordance with the outputs from the light receiving sections that receives the sub beam. For this reason, in order to increase the signal to noise ratio in the phase difference signal for the inner portion of the light beam, it is required to increase the diffraction efficiency in the region 211 of the optical diffraction element 207 and increase the light quantity of the sub beam on the light detector 210. At this time, the light quantity of the main beam on the disc 206 is inversely decreased, and it is difficult to obtain the light quantity that is required to carry out the recording onto the optical recording medium.

In conjunction with the above description, an optical head apparatus and an optical information recording or reproducing apparatus are disclosed in Japanese Laid Open Patent Application (JP-P2001-236666A). In this related art, an output light beam from the semiconductor laser is divided into three light beams of the 0-th light beam serving as a main beam and±first order diffractive light beams serving as sub beams by the optical diffraction element, and a track error signal is detected from each of the main beam and the sub beam. By the optical diffraction element, intensity distributions are different between the main beam and the sub beam when they are inputted to the objective lens. Thus, when there is the radial tilt in the disc, the phase of the track error signal is different between the main beam and the sub beam. The radial tilt signal is obtained from the difference in the phase of the track error signal. In this way, the detection of the radial tilt can be performed even for the discs of a write-once type and a rewritable type in which the sensibilities are high and the signals are not recorded in advance.

Also, an optical head apparatus and an optical head control apparatus are disclosed in Japanese Laid Open Patent Application (JP-P2003-16672A). In the optical head apparatus of this related art, a light beam from a light source is collected onto the record surface of a recording medium, and an objective lens receives a reflection light beam reflected from the recording medium. A polarization hologram has four quadrants divided by a first line corresponding to the radial direction on the record surface and a second line of the direction orthogonal to this. The reflection light beam which has passed through the objective lens passes through a substantially circular region that covers the four quadrants. The polarization hologram contains first to fourth diffractive regions which are formed in the four quadrants such that both sides of the circular region on the first line direction are left, and fifth and sixth polarization regions which are located outside the first to fourth diffractive regions and are installed to sandwich the first line therebetween, and correspond to the regions around the reflection light beam. The light detector has the first to fourth light receiving regions that receive the light beams diffracted in the first to fourth diffractive regions and obtain a tracking control signal, and the fifth and sixth light receiving regions which receive the light beams diffracted in the fifth and sixth diffractive regions and detect a shift quantity of the objective lens.

Also, an optical head and an information recording/reproducing apparatus are disclosed in Japanese Laid Open Patent Application (JP-A-Heisei, 11-73658). The optical head in this related art contains a light emitting device, a plurality of light receiving elements, an objective lens for collecting the light beam from the light emitting device onto the surface of an information recording medium; a composite diffractive element that is arranged in an optical path between the light emitting device and the objective lens, and spatially divides the light beam, which is reflected by the information recording medium and again passes through the objective lens, into a plurality of light beams and then guides the light beams to the plurality of light receiving elements; and a signal generating unit which generates a focus error signal and a tracking error signal in accordance with all or a part of the signals detected by the plurality of light receiving elements. When the tracking error signal is generated, an offset generated in association with the movement of the objective lens or an offset of the tracking signal generated by the tilt of the surface of the information recording medium is compensated.

### DISCLOSURE OF INVENTION

An object of the present invention is to provide an optical head apparatus in which a signal to noise ratio in an RF signal is high, and an optical information recording or reproducing apparatus that uses it.

Also, another object of the present invention is to provide an optical head apparatus in which a light quantity required to perform a recording on an optical recording medium can be obtained, and an optical information recording or reproducing apparatus that uses it.

Also, another object of the present invention is to provide an optical head apparatus in which a configuration of a circuit is simple, and an optical information recording or reproducing apparatus that uses it.

The optical head apparatus of the present invention includes a light source, an objective lens configured to focus an output light beam from the light source onto a disc-shaped optical recording medium, and a light detecting unit configured to receive a reflection light beam from the optical recording medium, and further includes an optical diffraction element configured to separate said reflection light beam into a first light beam group and a second light beam group, wherein the optical diffraction element generates the first light beam group from an entire section region of the reflection light beam and said second light beam group from at least a part of the section region of the reflection light beam. The light detector receives the first light beam group and the second light beam group by different light receiving sections, in order to detect a track error signal used for a track servo and a radial tilt signal indicating the radial tilt of the optical recording medium.

In the optical head apparatus of the present invention, preferably, the optical diffraction element is divided into a first region and a second region inside the section perpendicular to an optical axis of the input light beam in accordance with a distance perpendicular to the optical axis of the input light beam or a distance from a straight line that passes through the optical axis and is parallel to the tangential direction of the optical recording medium. The first light beam group is composed of the input light beam to the first region and the second region, and the second light beam group is composed of the input light beam to the first region or the input light beam to the second region.

The optical information recording or reproducing apparatus of the present invention includes the optical head apparatus of the present invention, and a detector for detecting the track error signal used for the track serve and the radial tilt signal from the output of the light receiving section.

In the optical information recording or reproducing apparatus of the present invention, the track error signal used for the track servo is preferably detected in accordance with the output from the light receiving section that receives the first light beam group. Also, the radial tilt signal is preferably detected in accordance with the output from the light receiving section for receiving the second light beam group.

### BRIEF DESCRIPTION OF DRAWINGS

FIG. 1 is a diagram showing the configuration of an optical head apparatus in a first related art;

FIG. 2 is a diagram showing the configuration of light receiving sections in a light detector and a calculating circuit, in the optical head apparatus in the first related art;

FIG. 3 is a diagram showing the configuration of the optical head apparatus in a second related art;

FIG. 4 is a plan view of an optical diffraction element in the optical head apparatus in the second related art;

FIG. 5 is a block diagram showing a configuration of an optical head apparatus according to a first exemplary embodiment of the present invention;

FIG. 6 is a plan view of an optical diffraction element in the optical head apparatus according to the first exemplary embodiment of the present invention;

FIGS. 7A and 7B are section views of the optical diffraction element in the optical head apparatus according to the first exemplary embodiment of the present invention;

FIG. 8 is a diagram showing a configuration of light receiving sections of a light detector and a calculating circuit in the optical head apparatus according to the first exemplary embodiment of the present invention;

FIGS. 9A to 9C are diagrams showing a phase difference signal in detection of a radial tilt, in the optical head apparatus according to the first exemplary embodiment of the present invention;

FIG. 10 is a plan view of another optical diffraction element in the optical head apparatus according to a second exemplary embodiment of the present invention;

FIG. 11 is a block diagram showing a configuration of the optical head apparatus according to a third exemplary embodiment of the present invention;

FIGS. 12A and 12B are sectional views of another optical diffraction element in the optical head apparatus according to the third exemplary embodiment of the present invention;

FIG. 13 is a diagram showing a configuration of light receiving sections of the light detector and a calculating circuit, in the optical head apparatus according to the third exemplary embodiment of the present invention;

FIG. 14 is a block diagram showing a configuration of the optical head apparatus according to a fourth exemplary embodiment of the present invention;

FIG. 15 is a block diagram showing a configuration of the optical head apparatus according to a fifth exemplary embodiment of the present invention; and

FIG. 16 is a diagram showing a configuration of the optical head apparatus according to a sixth exemplary embodiment of the present invention.

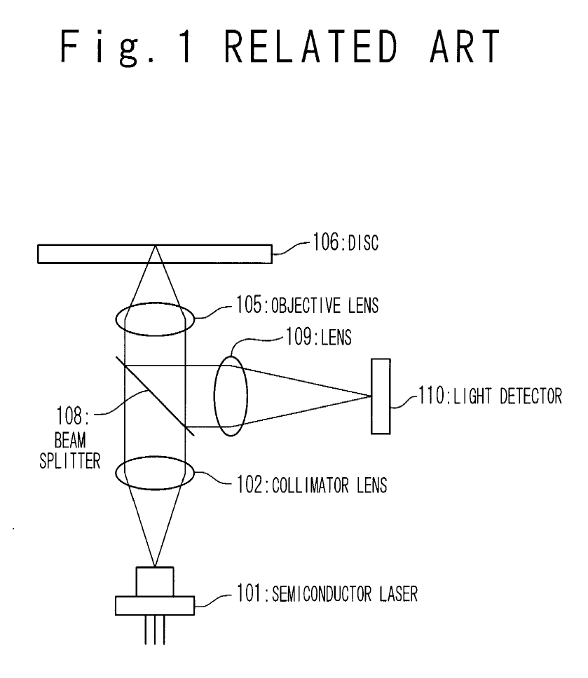

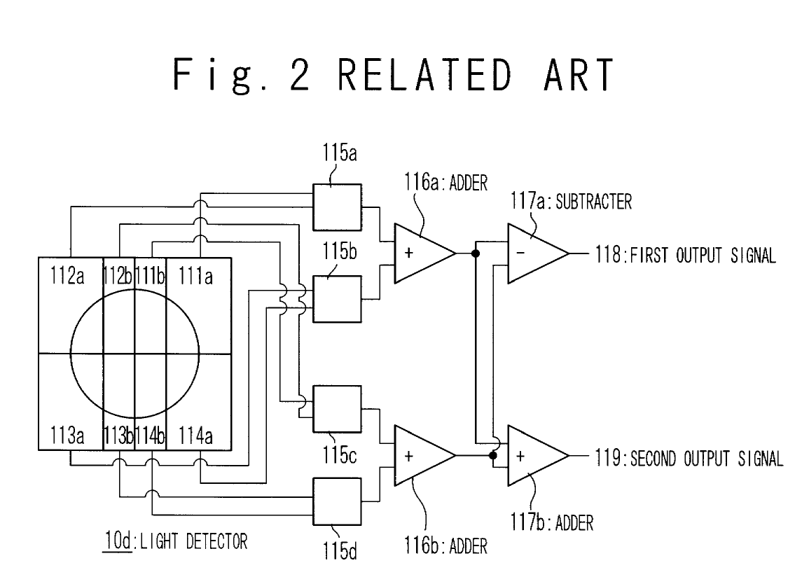

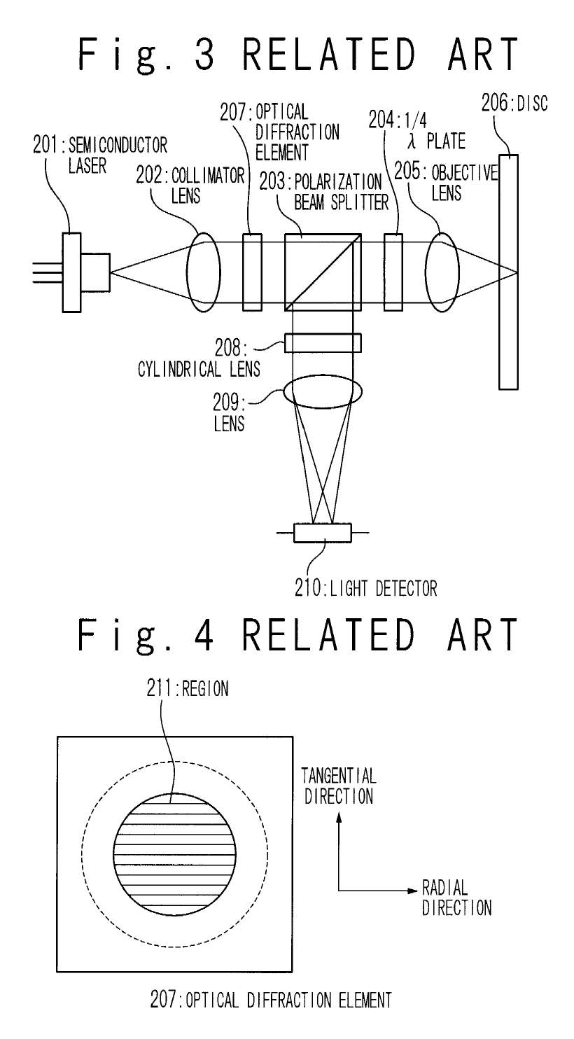

### BEST MODE FOR CARRYING OUT THE INVENTION

An optical head apparatus of the present invention will be described below in detail with reference to the attached drawings. Here, as the optical recording media that are presently popular, there are a reproduction-dedicated type (for example, DVD-ROM), a write-once type (for example, DVD-R), and a rewritable type (for example, DVD-RW). In the description of the following exemplary embodiments, there is no limit on the optical recording medium, and the present invention can be applied to any type of the optical recording media.

### First Exemplary Embodiment

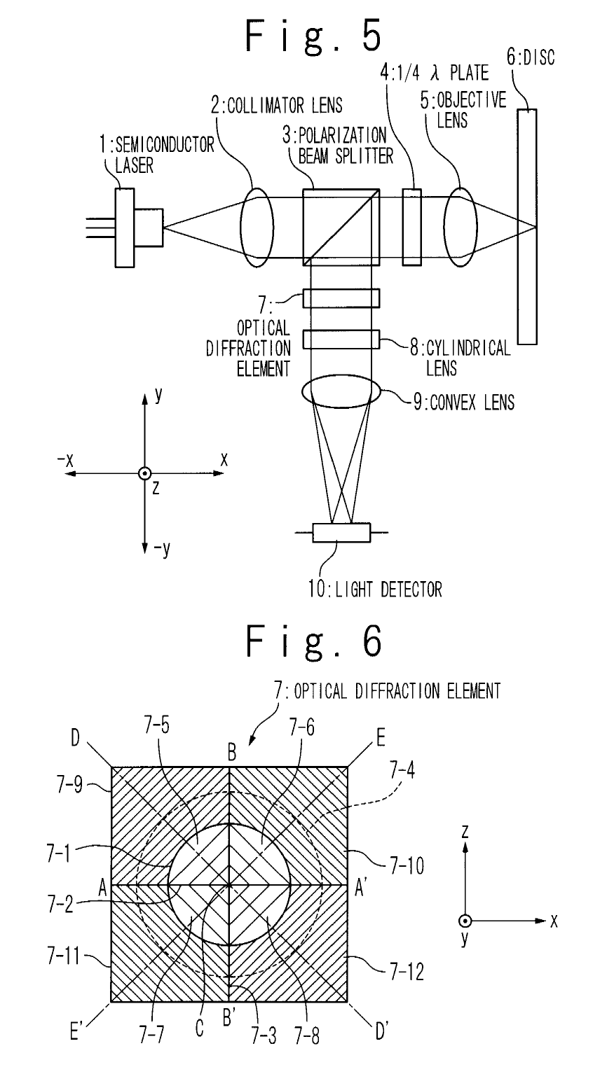

FIG. 5 is a block diagram showing a configuration of the optical head apparatus according to the first exemplary embodiment of the present invention. As shown in FIG. 5, the optical head apparatus in the first exemplary embodiment includes a semiconductor laser 1, a collimator lens 2, a polarization beam splitter 3, a ¼ wavelength plate 4, an objective lens 5, a disc 6, an optical diffraction element 7, a cylindrical lens 8, a convex lens 9 and a light detector 10.

The semiconductor laser 1 is a light source which outputs a light beam that is used to write a data onto the disc 6 serving as an optical recording medium or read the data from the disc. The collimator lens 2 is a lens for converting the light beam $ outputted by the semiconductor laser 1 into a parallel light beam. The polarization beam splitter 3 transmits light beam inputted thereto or reflects a reflection light beam. The ¼ wavelength plate 4 converts the transmitted linear polarization light beam into a circular polarization light beam. The objective lens 5 focuses the light beam supplied from the ¼ wavelength plate 4 onto the disc 6. The disc 6 is an optical recording medium, and holding of a data or reproduction of the data is optically performed. The disc 6 in this exemplary embodiment is, for example, DVD-ROM, DVD-RAM, DVD-R, and DVD-RW. The optical diffraction element 7 generates predetermined light beam groups in response to the reflection light beam supplied from the polarization beam splitter 3. It should be noted that the detailed configuration of the optical diffraction element 7 will be described later. The cylindrical lens 8 supplies the diffracted light beams outputted from the optical diffraction element 7 to the convex lens 9. The convex lens 9 collects the diffracted light beams supplied from the cylindrical lens 8. The light detector 10 receives the diffracted light beams to generate signals for determining the tilt of the disc 6.

The light beam outputted from the semiconductor laser 1 is made parallel by the collimator lens 2 and supplied as a P polarization light beam to the polarization beam splitter 3. The polarization beam splitter 3 transmits about 100% of the P polarization light beam inputted thereto to supply to the ¼ wavelength plate 4. The P polarization light beam supplied from the polarization beam splitter 3 transmits the ¼ wavelength plate 4 and consequently converted from the linear polarization light beam (hereinafter, referred to as a first linear polarization light beam) into a circular polarization light beam and then collected onto the disc 6 by the objective lens 5.

The reflection light beam from the disc 6 is supplied through the objective lens 5 to the ¼ wavelength plate 4. Since transmitting the ¼ wavelength plate 4, the reflection light beam is converted from the circular polarization light into a linear polarization light beam (hereafter, referred to as a second linear polarization light beam). At this time, the polarization direction of the second linear polarization light beam is orthogonal to the polarization direction of the first linear polarization light. The second linear polarization light beam outputted from the ¼ wavelength plate 4 is supplied as an S polarization light beam to the polarization beam splitter 3. The polarization beam splitter 3 reflects about 100% of the S polarization light beam to supply to the optical diffraction element 7. The S polarization light beam supplied from the polarization beam splitter 3 is diffracted by the optical diffraction element 7, transmits the cylindrical lens 8 and the convex lens 9 and received by the light detector 10.

FIG. 6 is a plan view of the optical diffraction element 7. A curve 7-1 shown in FIG. 6 indicates a circle having a diameter that is smaller than a diameter of an input light beam supplied to the optical diffraction element 7, on the light receiving plane of the optical diffraction element 7. Also, a straight line 7-2 passes through the optical axis of the input light beam supplied to the optical diffraction element 7 on the light receiving plane of the optical diffraction element 7, and is parallel to a direction (the radial direction of the disc 6 passing through the optical axis of the output light from the objective lens 5) in which the optical head apparatus scans the surface of the disc 6. Also, a straight line 7-3 is orthogonal to the straight line 7-2 on the light receiving plane of the optical diffraction element 7. Moreover, a curve 7-4 of the dotted line shown in FIG. 6 indicates an effective diameter of the objective lens 5 corresponding to the light receiving plane of the optical diffraction element 7. As shown in FIG. 6, the light receiving plane of the optical diffraction element 7 has a plurality of regions (7-5 to 7-12). In the plurality of regions, the curve 7-1, the straight line 7-2 and the straight line 7-3 are defined as the boundaries.

The diameter of the circle composed of a first region 7-5 to a fourth region 7-8 is smaller than the effective diameter of the objective lens 5 indicated by the dotted line shown in FIG. 6. As shown in FIG. 6, the regions of the light receiving plane of the optical diffraction element 7 are line-symmetrical with respect to the straight line 7-2 and line-symmetrical with respect to the straight line 7-3. Moreover, the optical diffraction element 7 is point-symmetrical with respect to the optical axis of the received light beam. The directions of the diffractive gratings in the first region 7-5, fourth region 7-8, a fifth region 7-9 and an eighth region 7-12 are all in the direction of +45°, and the directions of the diffractive gratings in the second region 7-6, the third region 7-7, a sixth region 7-10 and a seventh region 7-11 are all in the direction of −45°. All of the patterns of the diffractive gratings are same in pitch and straight lines, and the pitches in the first region 7-5 to the fourth region 7-8 are equal to two times the pitches in the fifth region 7-9 to the eighth region 7-12. The patterns of the diffractive gratings in the first region 7-5 and the fifth region 7-9, the patterns of the diffractive gratings in the second region 7-6 and the sixth region 7-10, the patterns of the diffractive gratings in the third region 7-7 and the seventh region 7-11, and the patterns of the diffractive gratings in the fourth region 7-8 and the eighth region 7-12 are continuous in the boundaries, respectively.

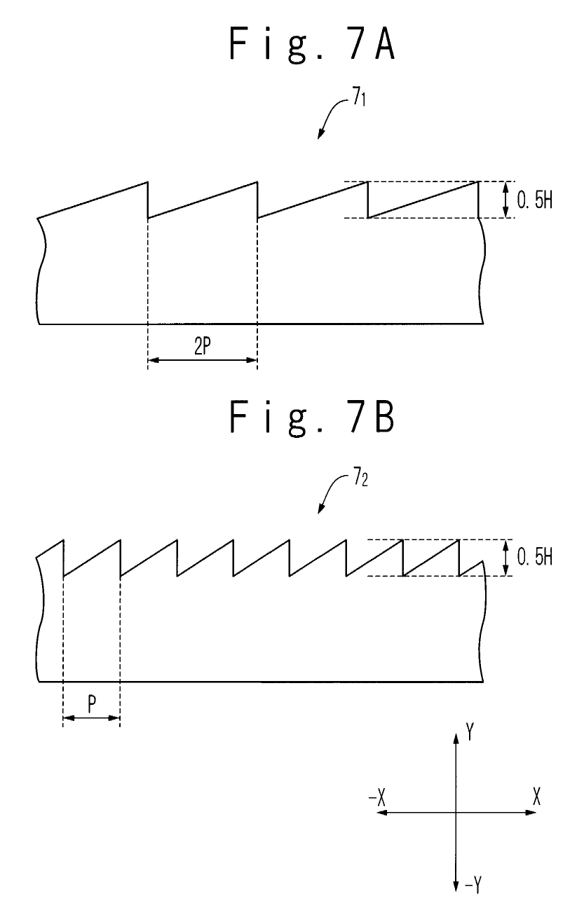

FIGS. 7A and 7B are sectional views of the optical diffraction element 7. With reference to FIGS. 7A and 7B, a section 71 and a section 72 indicate a part of the section when the optical diffraction element 7 is cut along the alternate long and short dash line D-D′ (or an alternate long and short dash line E-E′) in FIG. 6. FIG. 7A shows the section shape on the substrates in the first region 7-5 to the fourth region 7-8. Similarly, FIG. 7B shows the section shape on the substrate in the fifth region 7-9 to the eighth region 7-12. As shown in FIGS. 7A and 7B, the optical diffraction element 7 is constituted by the diffractive gratings having the different section shapes. As mentioned above, the light receiving plane of the optical diffraction element 7 is symmetrically configured. Thus, in the following description, the description is made by exemplifying a case that FIG. 7A is the section view of the first region 7-5 and FIG. 7B is the section view of the fifth region 7-9.

As shown in FIG. 7A, the section shape of the diffractive grating (hereafter, referred to as a first diffractive grating) in the first region 7-5 is the shape of saw teeth in which a pitch is 2 P and a height is 0.5 H. Similarly, as shown in FIG. 7B, the section shape of the diffractive grating (hereafter, referred to as a second diffractive grating) in the fifth region 7-9 is the shape of saw teeth in which a pitch is P and a height is 0.5 H. Here, when a wavelength of the semiconductor laser 1 is assumed to be λ and a refractive index of the diffractive grating is assumed to be n, the height H is represented by H=λ/(n−1).

Also, with reference to FIG. 7A and 7B, when the light beams are inputted to the optical diffraction element 7 in a direction indicated by an arrow Y, the light beams diffracted to the −X directions of the coordinates in FIGS. 7A and 7B are assumed to be the light beams of a negative diffractive order, and the light beams diffracted to the +X directions are assumed to be the light beams of a positive diffractive order. At this time, in the diffractive grating shown in FIG. 7A, a−second order diffractive efficiency is 1.6%, a−first order diffractive efficiency is 4.5%, a 0-th efficiency is 40.5%, a+first order diffractive efficiency is 40.5%, and a+second order diffractive efficiency is 4.5%. In the diffractive grating shown in FIG. 7B, when the pitch is regarded as 2 P similarly to the diffractive grating shown in FIG. 7A, the−second order diffractive efficiency is 4.5%, the−first order diffractive efficiency is 0.0%, the 0-th efficiency is 40.5%, the+first order diffractive efficiency is 0.0%, and the+second order diffractive efficiency is 40.5%. That is, the 0-th light beams includes 40.5% of the input light beam to the first region 7-5 to the eighth region 7-12, and the+first order diffractive light beams includes 40.5% of the input light beams to the first region 7-5 to the fourth region 7-8.

Here, the orientations of the saw teeth in the respective regions of the optical diffraction element 7 are set such that the light beam of the positive diffractive order is diffracted to the upper left side (the straight line C-D direction when a central point C is defined as a start point) of FIG. 6 in the first region 7-5 and the fifth region 7-9, the upper right side (the straight line C-E direction when the central point C is defined as the start point) of FIG. 6 in the second region 7-6 and the sixth region 7-10, the low left side (the straight line C-E′ direction when the central point C is defined as the start point) of FIG. 6 in the third region 7-7 and the seventh region 7-11, and the low right side (the straight line C-D′ direction when the central point C is defined as the start point) of FIG. 6 in the fourth region 7-8 and the eighth region 7-12, respectively.

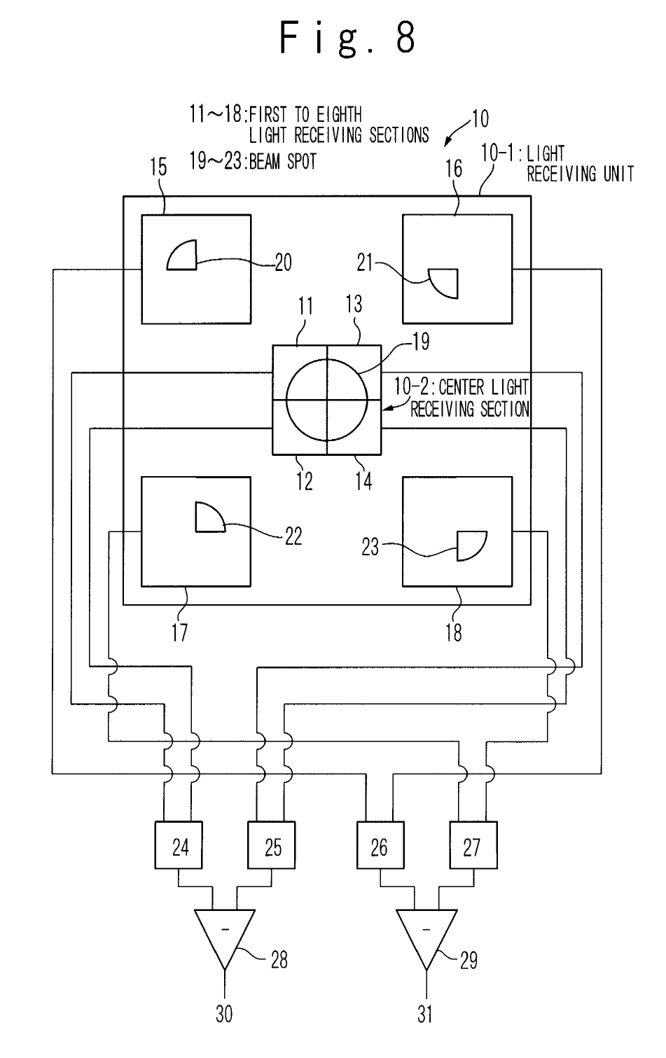

FIG. 8 shows a block diagram showing the configuration of a light receiving section and a calculating circuit in the light detector 10. As shown in FIG. 8, the light detector 10 includes a light receiving unit 10-1, a plurality of phase comparators 24-27, a first subtracter 28 and a second subtracter 29. Also, as shown in FIG. 8, the light receiving unit 10-1 contains a plurality of light receiving sections, namely, a first light receiving section 11 to an eighth light receiving section 18. The plurality of light receiving sections receive the light beams supplied from the optical diffraction element 7. Each of the first phase comparator 24 to the fourth phase comparator 27 compares the phases of the signals in response to the input signals. The first subtracter 28 calculates a difference between signals in response to the input signals. Similarly, the second subtracter 29 also calculates a difference of the input signals.

With reference to FIG. 8, a center light receiving section 10-2 receives a light spot 19. The light spot 19 corresponds to the 0-th light beam outputted from the first region 7-5 to the eighth region 7-12 in the optical diffraction element 7. As shown in FIG. 8, the center light receiving section 10-2 contains a plurality of four light receiving sections 11 to 14 that are divided by a division line parallel to the scanning direction of the optical head apparatus and a division line orthogonal to it. The light spot 19 corresponds to the light beam received by the plurality of light receiving sections. A light spot 20 corresponds to the+first order diffractive light beam from the first region 7-5 of the optical diffraction element 7 and is received by a single fifth light receiving section 15. A light spot 21 corresponds to the+first order diffractive light beam from the second region 7-6 of the optical diffraction element 7 and is received by a single sixth light receiving section 16. A light spot 22 corresponds to the+first order diffractive light beam from the third region 7-7 of the optical diffraction element 7 and is received by a single seventh light receiving section 17. A light spot 23 corresponds to the+first order diffractive light beam from the fourth region 7-8 of the optical diffraction element 7 and is received by a single eighth light receiving section 18. It should be noted that the light spots 19 to 23 are positioned by the cylindrical lens 8 and the convex lens 9 such that the intensity distribution is symmetrical with respect to a line in a −45° direction.

As shown in FIG. 8, the outputs of the first light receiving section 11 and the second light receiving section 12 are connected to the first phase comparator 24. The first phase comparator 24 calculates the phase difference between output signals from the first light receiving section 11 and the second light receiving section 12. The outputs of the third light receiving section 13 and the fourth light receiving section 14 are connected to the second phase comparator 25. The second phase comparator 25 calculates the phase difference between outputs signals from the third light receiving section 13 and the fourth light receiving section 14. The fifth light receiving section 15 and the sixth light receiving section 16 are connected to the third phase comparator 26. The third phase comparator 26 calculates the phase difference between output signals from the fifth light receiving section 15 and the sixth light receiving section 16. The seventh light receiving section 17 and the eighth light receiving section 18 are connected to the fourth phase comparator 27. The fourth phase comparator 27 calculates the phase difference between output signals from the seventh light receiving section 17 and the eighth light receiving section 18.

As shown in FIG. 8, the outputs of the first phase comparator 24 and the second phase comparator 25 are connected to the first subtracter 28. The first subtracter 28 calculates a difference between output signals from the first phase comparator 24 and the second phase comparator 25. Thus, a first output signal 30 is generated. The first output signal 30 is a phase difference signal for the entire light beam and a track error signal used for track servo in the optical head apparatus. The third phase comparator 26 and the fourth phase comparator 27 are connected to the second subtracter 29. The second subtracter 29 calculates a difference between output signals from the third phase comparator 26 and the fourth comparator 27. Thus, a second output signal 31 is generated. The second output signal 31 is a phase difference signal for the inner portion of the light beam and a radial tilt signal indicating a radial tilt of the disc 6.

It should be noted that when the outputs from the first light receiving section 11 to the fourth light receiving section 14 are represented as V11 to V14, respectively, a focus error signal is obtained from a calculation of (V11+V14)−(V12+V13) by using an astigmatism method. Also, the RF signal is obtained from a calculation of (V11+V12+V13+V14).

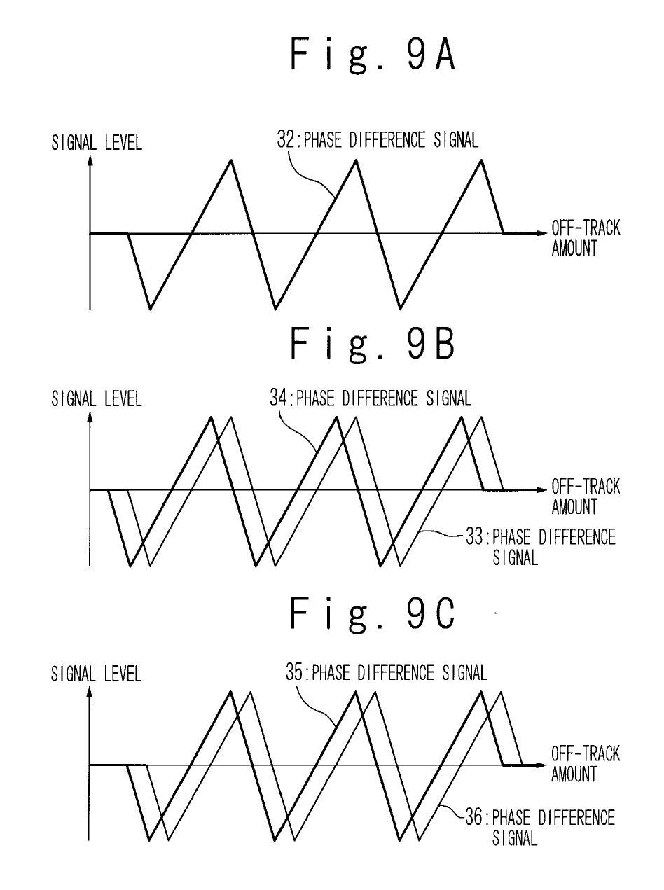

FIGS. 9A to 9C are diagrams showing various phase difference signals with regard to the detection of the radial tilt. In FIGS. 9A to 9C, the horizontal axis indicates an off track amount of the disc 6, and the vertical axis indicates a signal level. A phase difference signal 32 shown in FIG. 9A is the first output signal 30, and the second output signal 31 when there is no radial tilt in the disc 6. On the contrary, a phase difference signal 33 shown in FIG. 9B is the first output signal 30 when there is a positive radial tilt in the disc 6, and a phase difference signal 34 is the second output signal 31 when there is the positive radial tilt in the disc 6. Also, a phase difference signal 35 shown in FIG. 9C is the first output signal 30 when there is a negative radial tilt in the disc 6, and a phase difference signal 36 is the second output signal 31 when there is the negative radial tilt in the disc 6. The position at which the first output signal 30 intersects the 0-point from the−side to the+side corresponds to on the portion on a track.

If there is no radial tilt in the disc 6, the second output signal 31 becomes equal in phase to the first output signal 30 and becomes 0 on the track. On the contrary, when there is the positive radial tilt in the disc 6, the phase of the second output signal 31 is shifted to the left side on the drawing with respect to the first output signal 30 and becomes positive on the track. Also, when there is the negative radial tilt in the disc 6, the phase of the second output signal 31 is shifted to the right side on the drawing with respect to the first output signal 30 and becomes negative on the track. Thus, the second output signal 31 when the first output signal 30 is used to carry out the track servo can be used as the radial tilt signal.

### Second Exemplary Embodiment

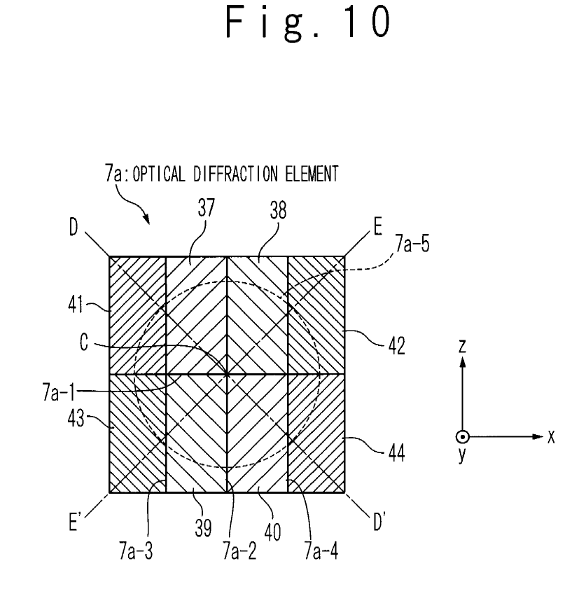

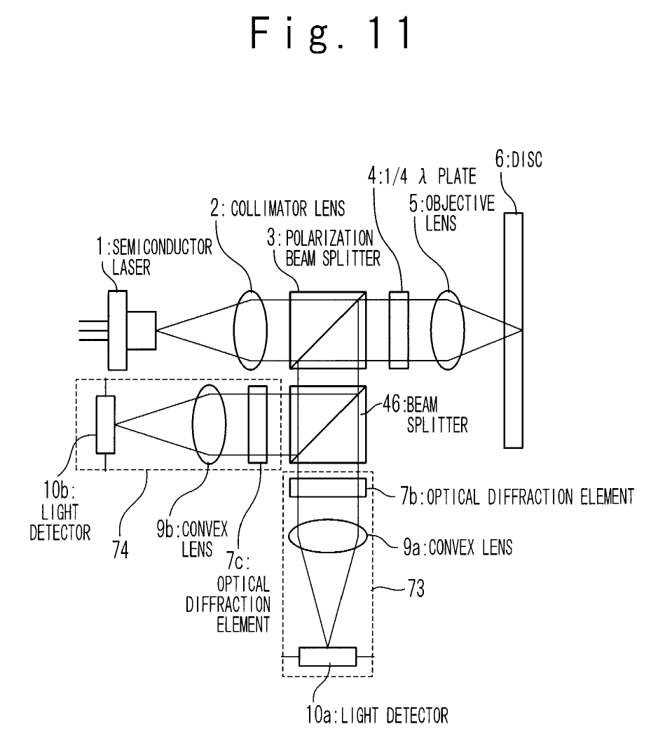

FIG. 10 is a plan view of a optical diffraction element 7a in the second exemplary embodiment. In the optical head apparatus according to the second exemplary embodiment of the present invention, the optical diffraction element 7 in the first exemplary embodiment is replaced with the optical diffraction element 7a shown in FIG. 10. With reference to FIG. 10, the optical diffraction element 7a contains a plurality of regions 37 to 44. As shown in FIG. 10, in the plurality of regions 37 to 40, a plurality of straight lines 7a-1 to 7a-4 are used as boundary lines. The straight line 7a-1 is the straight line, which passes through the optical axis of the input light beam to the optical diffraction element 7a and is parallel to the radial direction (the scanning direction of the optical head apparatus) of the disc 6. The straight line 7a-2 is the straight line, which passes through the optical axis of the input light beam and is perpendicular to the straight line 7a-1. Also, the straight line 7a-3 and the straight line 7a-4 are point-symmetrical with the straight line 7a-2 and are also the straight lines perpendicular to the straight line 7a-1. Also, the straight line 7a-5 indicates the effective diameter of the objective lens 5. As shown in FIG. 10, the width of the band constituted by the region 37 to the region 40 is smaller than the diameter of the objective lens 5 indicated by the straight line 7a-5. All the directions of the diffractive gratings in the region 37, the region 40, the region 41 and the region 44 are the directions of +45°. All the directions of the diffractive gratings in the region 38, the region 39, the region 42 and the region 43 are −45°. All patterns of the diffractive gratings have the shapes of the straight lines that are equal in pitch, and the pitches in the regions 37 to 40 are equal to two times the pitches in the regions 41 to 44. The patterns of the diffractive gratings in the regions 37 and 41, the patterns of the diffractive gratings in the regions 38 and 42, the patterns of the diffractive gratings in the regions 39 and 43, and the patterns of the diffractive gratings in the regions 40 and 44 are continuous in the boundaries, respectively.

The section view of the optical diffraction element 7a in the second exemplary embodiment is similar to the section view of the optical diffraction element 7 in the first exemplary embodiment. Also, in the second exemplary embodiment, the pattern of the light receiving sections in the light detector 10 and the arrangement of the light spots on the light detector 10 and the arrangement of the calculating circuit for the output from the light receiving sections of the light detector 10 are similar to those in the first exemplary embodiment shown in FIG. 8. Thus, the optical head apparatus in the second exemplary embodiment can generate a track error signal used for the track servo and the radial tilt signal, by using the method similar to the method described in the first exemplary embodiment. Also, various phase difference signals in the second exemplary embodiment are similar to those shown in FIGS. 9A to 9C. Therefore, the optical head apparatus in the second exemplary embodiment can detect the radial tilt of the disc 6 by using the method similar to the method described in the first exemplary embodiment.

In the above-mentioned first and second exemplary embodiments, when there is a residual error caused by the core bias of the disc 6 in the track error signal used for the track servo, the offset caused by the residual error is also generated in the phase difference signal for the inner portion of the light beam that is the radial tilt signal. However, when the signal obtained by subtracting the track error signal used for the track servo from the phase difference signal for the inner portion of the light beam is used as the radial tilt signal, the radial tilt can be detected without any generation of the offset caused by the residual error in the radial tilt signal.

In the optical head apparatus of the present invention, the optical diffraction element is not limited to the configuration of the optical diffraction element 7 in the first exemplary embodiment. For example, the optical diffraction element can be replaced with the different optical diffraction element that mainly generates the 0-th light beam and the+second order diffractive light beam in the regions 7-5 to 7-8 inside the circle having the diameter smaller than the effective diameter of the objective lens 5, and mainly generates the 0-th light beam and the+first order diffractive light beam in the outer regions 7-9 to 7-12. Also, in the optical head apparatus of the present invention, the optical diffraction element is not limited to the configuration of the optical diffraction element 7a in the second exemplary embodiment. For example, the optical diffraction element 7a can be replaced with the optical diffraction element that mainly generates the 0-th light beam and the+second order diffractive light beam in the regions 37 to 40 inside the band having the width smaller than the effective diameter of the objective lens 5, and mainly generates the 0-th light beam and the+first order diffractive light beam in the outer regions 41 to 44.

Even in those modification, similarly to the first exemplary embodiment, the track error signal used for the track servo is obtained from the output of the light receiving section in the light detector 10 that receives the 0-th light beam from the optical diffraction element, and the radial tilt signal is obtained from the outputs of the light receiving sections that receive the+first order diffractive light beams from the optical diffraction element.

In the light detector corresponding to the optical diffraction element 7 in the first exemplary embodiment or the optical diffraction element 7a in the second exemplary embodiment, the 0-th light beam, the+first order diffractive light beam and the+second order diffractive light beam from the optical diffraction element 7 or 7a may be received by the different light receiving sections. In that example, the track error signal used for the track servo is generated from the outputs of the light receiving sections that receive the 0-th light beam from the optical diffraction element, and the phase difference signal for the inner portion of the light beam is generated from the outputs of the light receiving sections that receive the+first order diffractive light beams from the optical diffraction element. Moreover, in the optical head apparatus, the phase difference signal for the outer portion of the light beam is generated from the outputs of the light receiving sections that receive the+second order diffractive light beams from the optical diffraction element.

In the optical head apparatus, the difference between the phase difference signal for the inner portion of the light beam and the phase difference signal for the outer portion of the light beam is defined as the radial tilt signal. Thus, even if the track error signal used for the track servo has the residual error caused by the core bias of the disc 6, the offset caused by the residual error generated in the phase difference signal for the inner portion of the light beam and the offset caused by the residual error generated in the phase difference signal for the outer portion of the light beam are cancelled out, which allows the radial tilt to be detected without any generation of the offset caused by the residual error in the radial tilt signal.

### Third Exemplary Embodiment

The optical head apparatus according to the third exemplary embodiment of the present invention will be described below. FIG. 11 is a block diagram showing the configuration of the optical head apparatus in the third exemplary embodiment. With reference to FIG. 11, the optical head apparatus in the third exemplary embodiment further contains a beam splitter 46, in addition to the configuration of the optical head apparatus in the first exemplary embodiment. Also, the optical head apparatus in the third exemplary embodiment includes a first detecting unit 73 for receiving the transmission light outputted from the beam splitter 46, and a second detecting unit 74 for receiving the reflection light. As shown in FIG. 11, the first detecting unit 73 includes an optical diffraction element 7b, a convex lens 9a and a light detector 10a. Similarly, the second detecting unit 74 includes an optical diffraction element 7c, a convex lens 9b and a light detector 10b.

With reference to FIG. 11, the output light beam from the semiconductor laser 1 is made parallel by the collimator lens 2 and supplied as the P polarization light to the polarization beam splitter 3. The polarization beam splitter 3 transmits about 100% of the P polarization light beam to supply to the ¼ wavelength plate 4. The P polarization light beam supplied to the ¼ wavelength plate 4 transmits the ¼ wavelength plate 4 and consequently converted from a linear polarization light (hereafter, referred to as the first linear polarization light) into a circular polarization light and focused or collected onto the disc 6 by the objective lens 5.

The reflection light beam from the disc 6 is supplied through the objective lens 5 to the ¼ wavelength plate 4. Since the reflection light beam transmits the ¼ wavelength plate 4, this is converted from the circular polarization light into a linear polarization light (hereafter, referred to as a second linear polarization light). At this time, the polarization direction of the second linear polarization light is orthogonal to the polarization direction of the first linear polarization light. The second linear polarization light beam outputted from the ¼ wavelength plate 4 is supplied as the S polarization light beam to the polarization beam splitter 3. The polarization beam splitter 3 reflects about 100% of the S polarization light beam to supply to the beam splitter 46. The beam splitter 46 outputs the transmission light beam and the reflection light beam in response to the supplied S polarization light beam. The transmission light beam outputted from the beam splitter 46 is diffracted by the optical diffraction element 7b, transmits the convex lens 9a and is received by the light detector 10a. Similarly, the reflection light beam outputted from the beam splitter 46 is diffracted by the optical diffraction element 7c, transmits the convex lens 9b and is received by the light detector 10b.

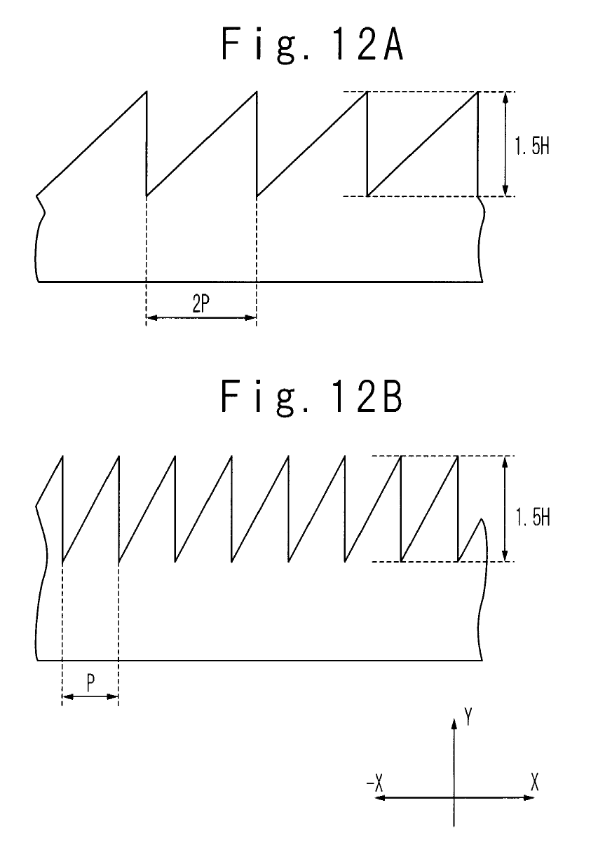

FIGS. 12A and 12B are sectional views of the optical diffraction element 7b. The layout of the light receiving plane of the optical diffraction element 7b in the third exemplary embodiment is similar to the optical diffraction element 7 in the first exemplary embodiment. Thus, in the following description of the third exemplary embodiment, the description of the light receiving plane of the optical diffraction element 7b is done correspondingly to FIG. 6 in the first exemplary embodiment. As for the optical diffraction element 7b, in the regions 7-5 to 7-8 in FIG. 6, the diffractive gratings having the section shape shown in FIG. 12A is formed on the substrate. Similarly, as for the optical diffraction element 7b, in the regions 7-9 to 7-12, the diffractive gratings having the section shape shown in FIG. 12B are formed on the substrate. The section shape of the diffractive grating shown in FIG. 12A has the shape of the saw teeth in which the pitch is 2 P and the height is 1.5 H, and the section shape of the diffractive grating shown in FIG. 12B has the shape of the saw teeth in which the pitch is P and the height is 1.5 H.

Here, when the wavelength of the semiconductor laser 1 is assumed to be A and the refractive index of the diffractive grating is assumed to be n, the height H is the value represented by H=λ/(n−1). Also, when the light beam is inputted to the optical diffraction element 7b in the direction indicated by the arrow Y, the light beam diffracted to the −X side of the coordinate is assumed to be the light beam of the negative diffractive order, and the light beam diffracted to the +X side of the coordinates is assumed to be the light beam of the positive diffractive order. At this time, in the diffractive grating shown in FIG. 12A, the−second order diffractive efficiency is 0.8%, the−first order diffractive efficiency is 1.6%, the 0-th efficiency is 4.5%, the+first order diffractive efficiency is 40.5%, and the+second order diffractive efficiency is 40.5%. In the diffractive grating shown in FIG. 12B, when the pitch is regarded as 2 P similarly to the diffractive grating shown in FIG. 12A, the−second order diffractive efficiency is 1.6%, the−first order diffractive efficiency is 0.0%, the 0-th efficiency is 4.5%, the+first order diffractive efficiency is 0.0%, and the+second order diffractive efficiency is 40.5%. That is, the+second order diffractive light beam includes 40.5% of the input light beams to the first region 7-5 to the eighth region 7-12 in FIG. 6, and the+first order diffractive light beam includes 40.5% of the input light beams to the first region 7-5 to the fourth region 7-8 of FIG. 6.

The orientations of the saw teeth in the respective regions of the optical diffraction element 7b in the third exemplary embodiment are same as those of the optical diffraction element 7 in the first exemplary embodiment. In short, the light beam of the positive diffractive order is set to be diffracted to the upper left side (the straight line C-D direction when the central point C is defined as the start point) of FIG. 6 in the first region 7-5 and the fifth region 7-9, the upper right side (the straight line C-E direction when the central point C is defined as the start point) of FIG. 6 in the second region 7-6 and the sixth region 7-10, the low left side (the straight line C-E′ direction when the central point C is defined as the start point) of FIG. 6 in the third region 7-7 and the seventh region 7-11, and the low right side (the straight line C-D′ direction when the central point C is defined as the start point) of FIG. 6 in the fourth region 7-8 and the eighth region 7-12, respectively.

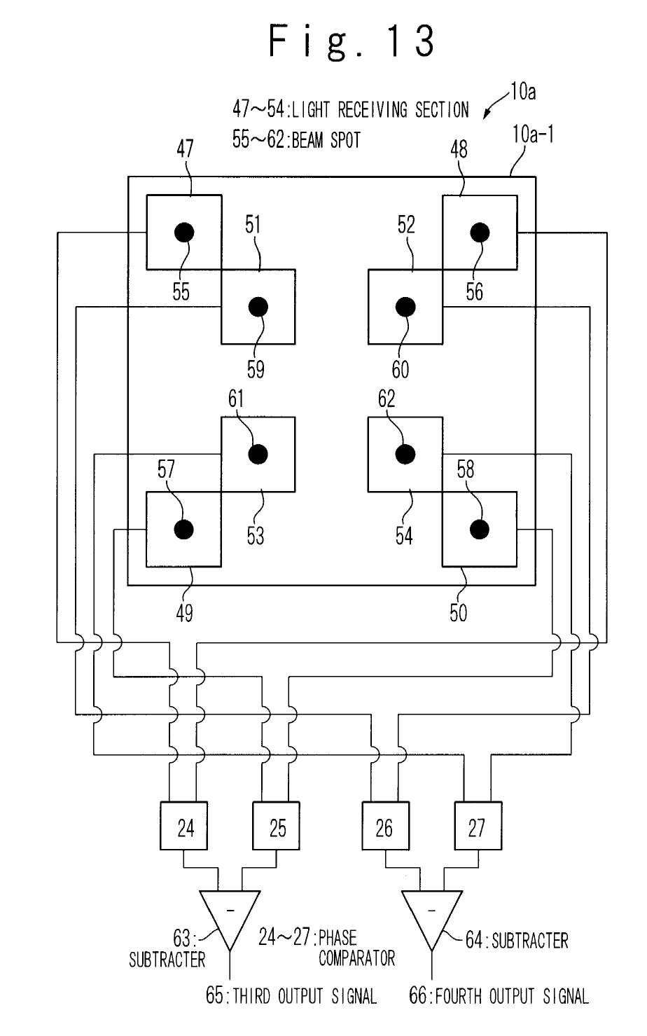

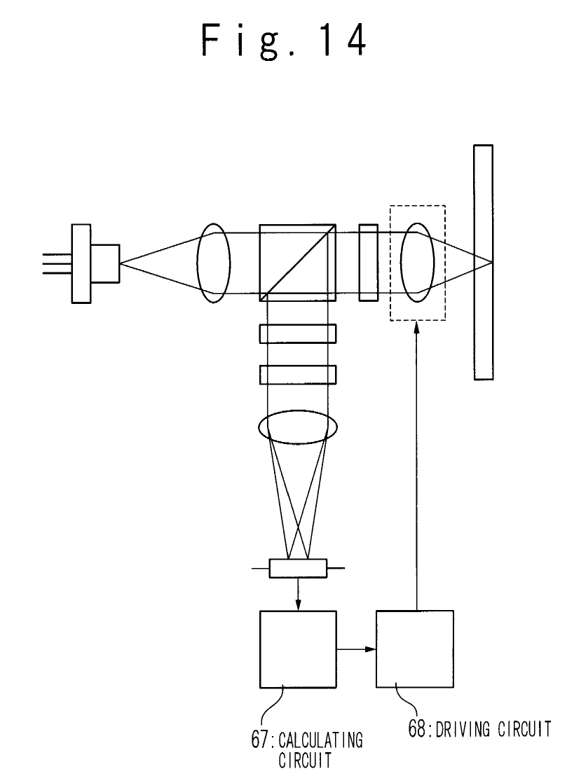

FIG. 13 is a block diagram showing a pattern of the light receiving sections in the light detector 10a in the third exemplary embodiment and the arrangement of the light spots on the light detector 10a and the arrangement of the calculating circuit for the outputs from the light receiving sections in the light receiving section 10a. As shown in FIG. 13, the light detector 10a includes a light receiving unit 10a-1, a plurality of phase comparators 24 to 27, a subtracter 63 and a subtracter 64. Also, as shown in FIG. 13, the light receiving unit 10a-1 contains a plurality of light receiving sections 47 to 54. Moreover, the light beams from the optical diffraction element 7b are received by the plurality of light receiving sections.

A light spot 55 is a light spot received by the single light receiving section 47, and the light spot 55 corresponds to the+second order diffractive light beams from the first region 7-5 and fifth region 7-9 in the optical diffraction element 7b. A light spot 56 corresponds to the+second order diffractive light beams from the second region 7-6 and sixth region 7-10 in the optical diffraction element 7b and is received by the single light receiving section 48. A light spot 57 corresponds to the+second order diffractive light beams from the third region 7-7 and seventh region 7-11 in the optical diffraction element 7b and is received by the single light receiving section 49. A light spot 58 corresponds the+second order diffractive light beams from the fourth region 7-8 and eighth region 7-12 in the optical diffraction element 7b and is received by the single light receiving section 50. A light spot 59 corresponds to the+first order diffractive light beam from the first region 7-5 in the optical diffraction element 7b and is received by the single light receiving section 51. A light spot 60 corresponds to the+first order diffractive light beam from the second region 7-6 in the optical diffraction element 7b and is received by the single light receiving section 52. A light spot 61 corresponds to the+first order diffractive light beam from the third region 7-7 in the optical diffraction element 7b and is received by the single light receiving section 53. A light spot 62 corresponds to the+first order diffractive light beam from the fourth region 7-8 in the optical diffraction element 7b and is received by the single light receiving section 54.

As shown in FIG. 13, the light receiving section 47 and the light receiving section 48 are connected to the first phase comparator 24, and the first phase comparator 24 calculates a phase difference in the output signal between the light receiving section 47 and the light receiving section 48. The light receiving section 49 and the light receiving section 50 are connected to the second phase comparator 25, and the second phase comparator 25 calculates a phase difference in the output signal between the light receiving section 49 and the light receiving section 50. The light receiving section 51 and the light receiving section 52 are connected to the third phase comparator 26, and the third phase comparator 26 calculates a phase difference in the output signal between the light receiving section 51 and the light receiving section 52. The light receiving section 53 and the light receiving section 54 are connected to the fourth comparator 27, and the fourth comparator 27 calculates a phase difference in the output signal between the light receiving section 53 and the light receiving section 54. The first phase comparator 24 and the second phase comparator 25 are connected to the subtracter 63, and the subtracter 63 calculates a difference between them and generates a third output signal 65. The third output signal 65 is a phase difference signal for the entire light beam and is used as the track error signal used for the track servo. Similarly, the third phase comparator 26 and the fourth comparator 27 are connected to the subtracter 64, and the subtracter 64 calculates a difference between them and generates a fourth output signal 66. The fourth output signal 66 is a phase difference signal for the inner portion of the light beam and is used as the radial tilt signal indicating the radial tilt of the disc 6. It should be noted that when the outputs from the plurality of light receiving sections 47 to 50 are represented as V47 to V50, respectively, the RF signal is obtained from the calculation of (V47+V48+V49+V50). The focus error signal is obtained from the output of the light detector 10b by using a knife edge method that uses the optical diffraction element 7c.

Various phase difference signals in the third exemplary embodiment are similar to those shown in FIGS. 9A to 9C. In the third exemplary embodiment, the method similar to the method described in the first exemplary embodiment can be used to detect the radial tilt of the disc 6.

Also, the optical diffraction element 7b in the third exemplary embodiment can be replaced with a optical diffraction element 7d (not shown) having the section structure shown in FIGS. 12A, 12B while having the flat surface structure shown in FIG. 10. A pattern of the light receiving sections in the light detector 10a and the arrangement of the light spots on the light detector 10a and the arrangement of the calculating circuit for the outputs from the light receiving sections in the light detector 10a are similar to FIG. 13. In this case, the method similar to the method described in the third exemplary embodiment is used to obtain the track error signal used for the track servo and the radial tilt signal. Also, various phase difference signals are similar to FIG. 9. Moreover, the method similar to the method described in the first exemplary embodiment can be used to detect the radial tilt of the disc 6.

In the third exemplary embodiment, when the track error signal used for the track servo has a residual error caused by the core bias of the disc 6, the offset caused by the residual error is also generated in the phase difference signal for the inner portion of the light beam that is the radial tilt signal. However, when the signal obtained by subtracting the track error signal used for the track servo from the phase difference signal for the inner portion of the light beam is used as the radial tilt signal, the radial tilt can be detected without any generation of the offset caused by the residual error in the radial tilt signal.

A modification is possible in which the optical diffraction element 7b in the third exemplary embodiment is replaced with a modification of the optical diffraction element that mainly generates the+second order diffractive light beams in the regions 7-5 to 7-8 inside the circle having the diameter smaller than the effective diameter of the objective lens 5, and mainly generates the+first order diffractive light beam and the+second order diffractive light beams in the outer regions 7-9 to 7-12. Also, when the optical diffraction element 7d is used, a modification is considered in which it is replaced with the optical diffraction element that mainly generates the+second order diffractive light beams in the regions 37 to 40 inside the band having the width smaller than the effective diameter of the objective lens 5, and mainly generates the+first order diffractive light beam and the+second order diffractive light beams in the outer regions 41 to 44. Even in those examples, the track error signal used for the track servo is obtained from the outputs of the light receiving sections that receive the+second order diffractive light beams from the optical diffraction element in the light detector 10a, and the radial tilt signal is obtained from the outputs of the light receiving sections that receive the+first order diffractive light beams from the optical diffraction element.

Moreover, in the light detector corresponding to the optical diffraction element 7b (or the optical diffraction element 7d) in the third exemplary embodiment, a modification is considered in which the+first order diffractive light beam,+second order diffractive light beam and+fourth order diffractive light beam from the optical diffraction element are received by the light receiving sections of the modification. In this case, the track error signal used for the track servo is obtained from the outputs of the light receiving sections for receiving the+second order diffractive light beams from the optical diffraction element, and the phase difference signal for the inner portion of the light beams is obtained from the outputs of the light receiving sections for receiving the+first order diffractive light beams from the optical diffraction element. Moreover, the phase difference signal for the outer portion of the light beams is obtained from the outputs of the light receiving sections for receiving the+fourth order diffractive light beams from the optical diffraction element. Also, the difference between the phase difference signal for the inner portion of the light beam and the phase difference signal for the outer portion of the light beam is used as the radial tilt signal. For this reason, even if the track error signal used for the track servo has the residual error caused by the core bias of the disc 6 and the like, the offset caused by the residual error generated in the phase difference signal for the inner portion of the light beams and the offset caused by the residual error generated in the phase difference signal for the outer portion of the light beams is cancelled, which allows the radial tilt to be detected without any generation of the offset caused by the residual error in the radial tilt signal.

### Fourth Exemplary Embodiment

An optical information recording or reproducing apparatus according to the fourth exemplary embodiment of the present invention will be described below with reference to the drawings. FIG. 14 is a block diagram exemplifying the configuration of the optical information recording or reproducing apparatus according to the fourth exemplary embodiment of the present invention. With reference to FIG. 14, the optical information recording or reproducing apparatus of the fourth exemplary embodiment contains the optical head apparatus in the first exemplary embodiment, a calculating circuit 67, and a driving circuit 68. The calculating circuit 67 calculates the radial tilt signal in accordance with the output from each light receiving section in the light detector 10. The driving circuit 68 operates an actuator (not shown) and tilts the objective lens 5 so that the radial tilt signal becomes 0. Thus, the radial tilt of the disc 6 is compensated, which removes the bad influence on the recording or reproducing property.

### Fifth Exemplary Embodiment

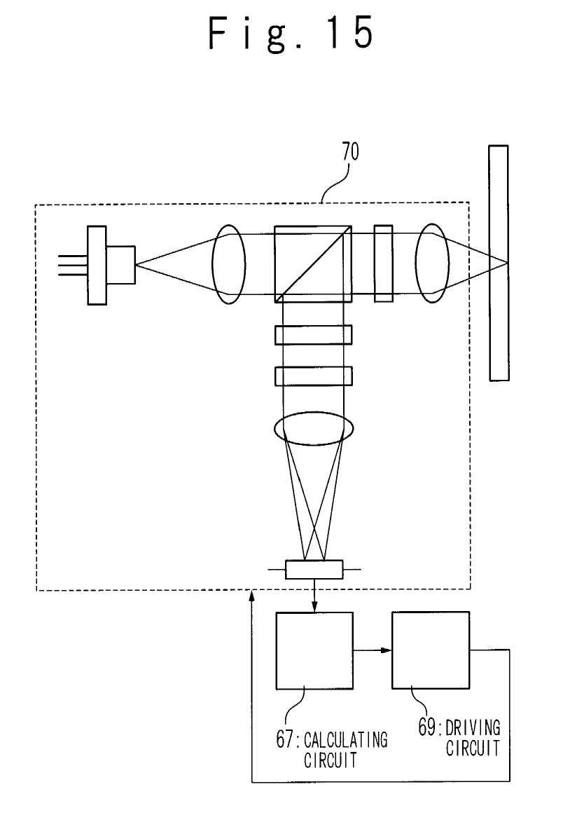

The optical information recording or reproducing apparatus according to the fifth exemplary embodiment of the present invention will be described below with reference to the drawings. FIG. 15 is a block diagram showing the configuration of the optical information recording or reproducing apparatus according to the fifth exemplary embodiment of the present invention. As shown in FIG. 15, the optical information recording or reproducing apparatus of the fifth exemplary embodiment contains the optical head apparatus in the first exemplary embodiment, the calculating circuit 67, and a driving circuit 69. The calculating circuit 67 calculates the radial tilt signal in accordance with the output from each light receiving section in the light detector 10. The driving circuit 69 operates a motor (not shown) and entirely tilts an optical head apparatus 70 so that the radial tilt signal becomes 0. Thus, the radial tilt of the disc 6 is compensated, which removes the bad influence on the recording or reproducing property.

### Sixth Exemplary Embodiment

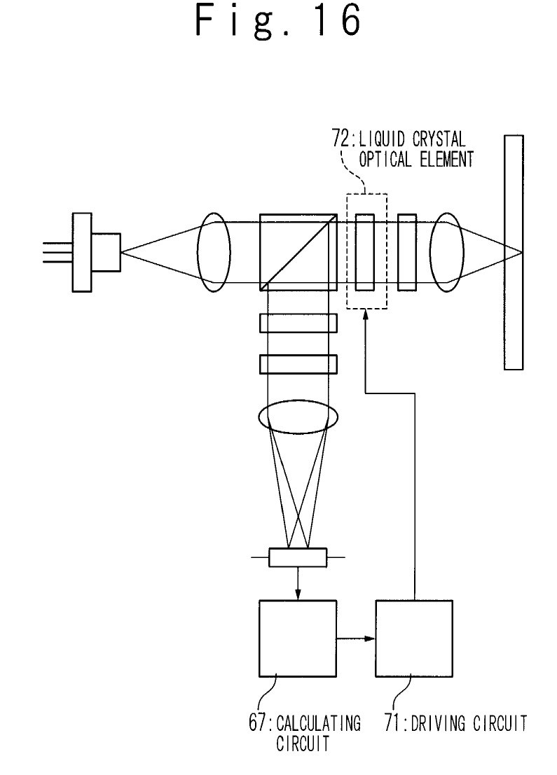

The optical information recording or reproducing apparatus according to the sixth exemplary embodiment of the present invention will be described below with reference to the drawings. FIG. 16 is a block diagram showing the configuration of the optical information recording or reproducing apparatus according to the sixth exemplary embodiment of the present invention. As shown in FIG. 16, the optical information recording or reproducing apparatus of the sixth exemplary embodiment contains the optical head apparatus in the first exemplary embodiment, the calculating circuit 67, a driving circuit 71 and a liquid crystal optical element 72. The calculating circuit 67 calculates the radial tilt signal in accordance with the output from each light receiving section in the light detector 10. The driving circuit 71 is a circuit for applying a voltage to the liquid crystal optical element 72 so that the radial tilt signal becomes 0. The liquid crystal optical element 72 is an element which is divided into a plurality of regions and in which the voltage applied to each region is changed, thereby changing the coma aberration for the transmission light beam. The driving circuit 71 adjusts the voltage applied to the liquid crystal optical element 72 in accordance with the output from each light receiving section in the light detector 10, and generates the coma aberration, which cancels the coma aberration caused due to the radial tilt in the disc 6 in the liquid crystal optical element 72. Thus, the radial tilt of the disc 6 is compensated, which removes the bad influence on the recording or reproducing property. Also, the optical information recording or reproducing apparatus of the present invention provides its effect, even in the implementation in which the calculating circuit, driving circuit and the like in the fourth to sixth exemplary embodiments are applied to the optical head apparatus in the second and third exemplary embodiments. Thus, the above-mentioned exemplary embodiments can be combined when any conflict is not generated in its configuration and operation.

The optical head apparatus and optical information recording or reproducing apparatus of the present invention use the phase difference signal for a first light beam group as the track error signal used for the track servo, and use the phase difference signal for a second light beam group as the radial tilt signal. Thus, the adder and the subtracter except the circuit for obtaining the phase difference signal for the first light beam group and the phase difference signal for the second light beam group are not required, which simplifies the configuration of the circuit. Also, the RF signal is given as a summation of the outputs from the four light receiving sections, and the number of the light receiving sections to obtain the summation of the outputs is small. Thus, the noise of the circuit for performing the current−voltage conversion on the outputs from the respective light receiving sections is low, and the signal to noise ratio in the RF signal is high.

The optical head apparatus and optical information recording or reproducing apparatus of the present invention do not use the sub beam that requires a large light quantity. Thus, the light quantity of the recording beam on the optical recording medium is large, thereby obtaining the light quantity required to carry out the recording onto the optical recording medium. Therefore, the effects of the optical head apparatus and optical information recording or reproducing apparatus of the present invention are such that the configuration of the circuit for obtaining the track error signal used for the track servo and the radial tilt signal is simple, and such that the signal to noise ratio in the RF signal is high, and such that the light quantity required to carry out the recording onto the optical recording medium is attained.

The reason why the configuration of the circuit for obtaining the track error signal used for the track servo and the radial tilt signal is simple is that since the phase difference signal for the first light beam group is used as the track error signal used for the track servo and the phase difference signal for the second light beam group is used as the radial tilt signal, and the adder and the subtracter except the circuit for obtaining the phase difference signal for the first light beam group and the phase difference signal for the second light beam group are not required. Also, the reason why the signal to noise ratio in the RF signal is high is that since the RF signal is given as the summation of the outputs from the four light receiving sections and the number of the light receiving sections for determining the summation of the outputs is small, and the noise of the circuit for performing the current−voltage conversion on the outputs from the respective light receiving sections is low. The reason why the light quantity required to perform the recording on the optical recording medium is obtained is that since the sub beam requiring the large light quantity is not used, the light quantity of the recording beam on the optical recording medium is large.

1. An optical head apparatus comprising:
a light source;
a lens configured to focus an output light beam from said light source onto a disc-shaped optical recording medium;
a light detecting unit configured to receive a reflection light beam from said optical recording medium; and
an optical diffraction element provided between said lens and said light detecting unit and configured to separate said reflection light beam into a first light beam group and a second light beam group,
wherein said optical diffraction element generates said first light beam group from an entire section region of said reflection light beam and said second light beam group from at least a part of the section region of said reflection light beam, and
said light detecting unit comprises:
a first light receiving section configured to receive said first light beam group; and
a second light receiving section configured to receive said second light beam group.

2. The optical head apparatus according to claim 1, wherein said optical diffraction element has a light reception plane which receives said reflection light beam and is perpendicular to an optical axis of said reflection light beam,
said light reception plane has a boundary determined based on a distance from an optical axis point corresponding to an intersection point of said optical axis and said light reception plane or a distance from a line passing through said optical axis point on said light reception plane, and has first and second regions formed based on said boundary, said first region and said second region are different regions with respect to said boundary,
said first light beam group is generated from a part of said reflection light beam which is inputted to said first region and a part of said reflection light beam which is inputted to said second region, and
said second light beam group is generated from both or one of a part of said reflection light beam which is inputted to said first region and a part of said reflection light beam which is inputted to said second region.

3. The optical head apparatus according to claim 2, wherein said optical diffraction element has said boundary of a circular shape with respect to said optical axis point as a center on said light reception plane,
said first region is a region inside said boundary, and
said second region is a region outside said boundary.

4. The optical head apparatus according to claim 2, wherein said optical diffraction element has first and second linear boundaries provided in parallel on said light reception plane,
said first and second boundaries are provided symmetrically with respect to a line passing through said optical axis point on said light reception plane,
said first region is provided between said first and second boundaries, and
said second region is provided as a region other than said first region.

5. The optical head apparatus according to claim 2, wherein said optical diffraction element has a first line passing through said optical axis point on said light reception plane and a second line passing through said optical axis point on said light reception plane and orthogonal to said first line,
each of said first and second regions comprises a plurality of small regions, and
said plurality of small regions comprises four regions symmetrical with respect to said first and second lines.

6. The optical head apparatus according to claim 2, wherein said first light beam group comprises a 0-th order light beam from said first region and a 0-th order light beam from said second region, and
said second light beam group comprises both or one of a first order of diffraction light beam from said first region and a first order of diffraction light beam from said second region.

7. The optical head apparatus according to claim 2, wherein said first light beam group comprises a first order of diffraction light beam from said first region and a first order of diffraction light beam from said second region, and
said second light beam group comprises both or one of a second order of diffraction light beam from said first region and a second order of diffraction light beam from said second region.

8. An optical information recording or reproducing apparatus comprising:
said optical head apparatus which comprises:
a light source,
a lens configured to focus an output light beam from said light source onto a disc-shaped optical recording medium,
a light detecting unit configured to receive a reflection light beam from said optical recording medium, and
an optical diffraction element provided between said lens and said light detecting unit and configured to separate said reflection light beam into a first light beam group and a second light beam group, wherein said optical diffraction element generates said first light beam group from an entire section region of said reflection light beam and said second light beam group from at least a part of the section region of said reflection light beam,
wherein said light detecting unit comprises first and second light receiving sections configured to receive said first light beam group and said second light beam group, respectively, and
a signal detecting section configured to detect a track error signal used for track servo and a radial tilt signal indicating a radial tilt of said optical recording medium from outputs of said first and second light receiving sections of said optical head apparatus.

9. The optical information recording or reproducing apparatus according to claim 8, wherein said signal detecting section detects said track error signal used for the track servo based on the output of said first light receiving section.

10. The optical information recording or reproducing apparatus according to claim 8, wherein said signal detecting section detects said radial tilt signal based on the output of said second light receiving section.

11. The optical information recording or reproducing apparatus according to claim 10, wherein a signal detected based on the output of said second light receiving section when the track servo is carried out based on said track error signal is used as said radial tilt signal.

12. The optical information recording or reproducing apparatus according to claim 10, wherein a signal obtained by subtracting said track error signal used for the track servo from a signal detected based on the output of said second light receiving section when the track servo is carried out based on said track error signal is used as said radial tilt signal.

13. The optical information recording or reproducing apparatus according to claim 8, further comprising:
a correcting section configured to correct the radial tilt of said optical recording medium.

14. The optical information recording or reproducing apparatus according to claim 13, wherein the radial tilt of said optical recording medium is corrected by tilting said lens in a radial direction of said optical recording medium.

15. The optical information recording or reproducing apparatus according to claim 13, wherein the radial tilt of said optical recording medium is corrected by tilting an entire of said optical head apparatus in a radial direction of said optical recording medium.

16. The optical information recording or reproducing apparatus according to claim 13, wherein a liquid crystal optical element is provided between said light source and said lens, and
the radial tilt of said optical recording medium is corrected by applying a voltage to said liquid crystal optical element.
